(19) United States
(12) Patent Application Publication
(10) Pub. No.: US 2006/0072845 A1
(43) Pub. Date: Apr. 6, 2006

(54) Method of processing an input image by means of multi-resolution

(75) Inventors: Kai Eck, Aachen (DE); Holger Fillbrandt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,622

(22) PCT Filed: Dec. 10, 2003
(86) PCT No.: PCT/IB03/05902

§ 371 Date: Jun. 10, 2005

(30) Foreign Application Priority Data
Dec. 18, 2002 (EP) 02102809.7

(51) Int. Cl. G06K 9/40; G06K 9/00

(52) U.S. Cl. 382/265; 382/132

(57) ABSTRACT

The invention relates to a method of multi-resolution with gradient-adaptive filtering (MRGAF) of X-ray images in real time. For an image strip of 2K adjacent rows, a resolution into a Laplacian pyramid (L0, . . . L3) and a Gaussian pyramid (G0, . . . G3) is carried out up to the K-th stage. By limiting a processing operation to such a strip, it is possible to keep all relevant data ready in a local memory with rapid access (cache). A further acceleration compared to the conventional algorithm is achieved by calculating the gradient (D) from the Gaussian pyramid representations. By virtue of these and other optimization measures, it is possible to increase a multi-resolution with gradient-adaptive filtering to a processing rate of more than thirty (768 (E 564) images per second.

The invention relates to a method and a data processing unit for processing an input image, in particular for the multi-resolution and gradient-adaptive filtering of an X-ray image in real time.

The automated evaluation of images takes place in a large number of different fields of application. The processing of fluoroscopic X-ray images considered in greater detail below should therefore be understood to be merely one example. In order to minimize the amount of X-radiation to which a patient and the staff are subjected, X-ray images are taken with as low a radiation dose as possible. However, there is a risk that important image details will become lost in the image noise. In order to prevent this, attempts are made to suppress the noise by using spatial and temporal filters on the X-ray images or image sequences, without destroying relevant image information in the process.

Within the context of such image processing, what is known as multi-resolution of the input image is often carried out. The input image is in this case resolved into a sequence of detail images, where the detail images each contain image information from an associated region or strip at (spatial) frequencies. In addition, the detail images are adapted in terms of their resolution, i.e. the number of image points for the representation of the content of the image, to their respective frequency range. By modifying detail images, it is possible to have an influence on certain frequency ranges in a targeted manner. After the modification, the detail images can be put back together again to form an output image.

From WO 98/55916 A1 and EP 996 090 A2, in this respect an effective method for the post-processing of X-ray images is known, in which a multi-resolution takes place and the detail images obtained thereby are modified using filters, the coefficients of which have been adapted on the basis of image gradients. The gradients in each case stem from the coarser resolution stages of the multi-resolution. In this method, which is referred to as MRGAF (Multi-Resolution Gradient Adaptive Filtering), low-pass filtering is carried out to a lesser extent perpendicular to image structures such as lines or edges than in the direction of the structures, so that a suppression of noise takes place that allows information to be obtained. On account of the great calculation effort that is required, however, the method can to date only be carried out offline on stored images or image sequences.

In view of this background, it is an object of the present invention to provide means for the more efficient processing of input images using multi-resolution, where preferably it should be possible to carry out image analysis in real time.

This object is achieved by a method having the features as claimed in claim 1, by a data processing unit having the features as claimed in claim 8 and by an X-ray system having the features as claimed in claim 10. Advantageous refinements are given in the dependent claims.

The method according to the invention is used for processing an input image comprising N rows of image points. Typically, the image points are arranged in a rectangular grid having columns perpendicular to the rows, although other arrangements having a row structure, such as e.g. hexagonal grids, are also possible. The input image may in particular be a digitized fluoroscopic X-ray image, although the method is not restricted to this and can be advantageously used in all comparable application instances in which a multi-resolution of an image takes place. The method comprises the following steps:

a) An image strip which comprises n<N adjacent rows of the input image is resolved into a sequence of K detail images, where the detail images in each case contain just a partial range of the spatial frequencies of the image strip. A multi-resolution is thus carried out using the strip-like section of the overall input image.

b) At least one of the detail images obtained in step a) is modified, for example using a predefined filter or a filter that is calculated from the image strip. Preferably, all the information that is required for the modification is available in the image strip.

c) An output image strip is reconstructed from the detail images or the modified detail images (if the latter exist).

d) The above steps a), b) and c) are repeated for other image strips of the input image, that is to say they are carried out in an analogous manner with calculation of a corresponding output image strip. Other values for the strip width n and/or the resolution depth K may also be assumed where appropriate.

e) An output image is reconstructed from the calculated output image strips.

As a result, in the above method, an output image is therefore generated from an input image (said output image being of the same size or of a different size), where modifications of the desired type have been carried out in some or all spatial frequency ranges of the input image. Compared with conventional multi-resolution with a modification of detail images, the difference with this method is that the multi-resolution takes place in sections on image strips of in each case n rows. Each image strip is in this case resolved to the stage K and then synthesized again to give an output image strip. The advantage of this procedure is that it is particularly suitable for efficient implementation on a data processing system, since the memory requirement for the processing of an image strip is accordingly smaller than for the processing of the full image, so that the method can be carried out using a working memory with rapid access. As a result, a gain in speed can be achieved that is so great that in many cases for the first time it is practical for the multi-resolution to be carried out in real time.

According to one specific refinement of the method, in the multi-resolution of step a), each image strip is resolved into a Laplacian pyramid and a Gaussian pyramid with in each case K stages. In stage j of a Gaussian pyramid, the stage input image is the output image of the preceding stage (j−1), and the output image (hereinafter referred to as “Gaussian pyramid representation of stage j”) is the stage input image that has been modified by low-pass filtering and subsequent resolution reduction. The output image of the Laplacian pyramid at stage j (hereinafter referred to as “Laplacian pyramid representation of stage j”) is obtained by subtracting the Gaussian pyramid representation of the same stage j, the resolution of which has been increased again and which has been low-pass-filtered, from the Gaussian pyramid representation of the preceding stage (j−1). The resolution of an input image into a Laplacian pyramid or Gaussian pyramid is frequently used in medical image processing and is particularly suitable for use on image strips.

Preferably, in steps a) to d), the image strip subjected to multi-resolution is in each case 2^{K} rows wide, where K is the number of resolution stages of the multi-resolution. Image strips having a width of 2^{K} have the minimum width necessary for resolution into a Laplacian pyramid or Gaussian pyramid to the stage K, if at each stage of the resolution a reduction of the rows and columns by in each case a factor of 2 takes place. The detail image of the coarsest stage has the minimum width of one row for such an image strip. Furthermore, the image strips are optionally offset by in each case (2^{K}−1) rows with respect to one another, or in other words overlap one another by in each case one row. Such an overlapping, which preferably is also present on all resolution stages of the image strips, provides the necessary information for filter operations taking place at the edge of the new, non-overlapping region. Depending on the width of the filter used, there may also be instances of overlapping of more than one row wide between the image strips.

The type of modifications carried out with the detail images may differ depending on the application instance. Preferably, the modification of a detail image of the resolution stage j<K is in the use of a filter, where the coefficients of this filter depend on at least one gradient calculated from the image strip. Since gradients of the image reflect the position of local structures in the image, they can be used to define anisotropic filters, the use of which leaves the structures unchanged or even amplifies them, and suppresses any noise along the structures.

Preferably, the above method is combined with a resolution into a Gaussian pyramid and a Laplacian pyramid, and the gradient is calculated from the Gaussian pyramid representation of the resolution stage j and is used for the filtering of the Laplacian pyramid representation of the same stage j. This has the advantage that all information required for the modification can be obtained from the data of the resolution stage j, so that the modification can be carried out directly during the calculation of this stage.

According to a special design of the above gradient-adaptive filtering of detail images, the filter coefficients α(Δ\vec{x},\vec{x}) are calculated from the coefficients β(Δ\vec{x}) of a predefined filter, such as for example a binomial filter, where \vec{x} is the image point processed by the filter and Δ\vec{x} is the position of the respective coefficient in relation to the center of the filter, and where the following formula applies:
α(Δ\vec{x},\vec{x})=β(Δ\vec{x})[r(\vec{g}(\vec{x}), Δ\vec{x})]² (1)

Herein, \vec{g}(\vec{x}) is the gradient at the image position \vec{x} and 0≦r≦1. Where the weighting function r(\vec{g},\vec{x})<1, the corresponding filter coefficients β are decreased and the contribution thereof to the result of filtering is reduced. In this way, a noise contribution is suppressed at the corresponding positions of an image.

The weighting function r is preferably defined as follows:

$$r ( {g}^{->} , Δ {x}^{->} ) = ( \frac{1}{1 + c [ {g}^{->} ] {( {g}^{->} \cdot Δ {x}^{->} )}^{2}} ) \qquad ( 2 )$$

where c[\vec{g}] is a factor that preferably depends on the gradient field \vec{g} and the variance thereof. The above definition of the factor r has the desired property that r=1 in directions Δ\vec{x} perpendicular to the gradient \vec{g}(\vec{x}), and that r is minimal in directions Δ\vec{x} parallel to \vec{g}(\vec{x}). The definitions for the calculation of α and r are considerably easier in terms of their calculation effort than the definitions given in WO 98/55916 A1, with the results being approximately identical.

The invention furthermore relates to a data processing unit for processing a digital input image comprising N rows of image points, which data processing unit contains a system memory and a cache memory. The data processing unit is intended to carry out the following processing steps:

a) resolution of an image strip comprising n<N adjacent rows of the input image into a sequence of K detail images, which in each case contain just some of the spatial frequencies of the input image;

b) modification of at least one of the detail images;

c) reconstruction of an output image strip from the—possibly modified—detail images;

d) repetition of steps a), b) and c) for other image strips of the input image;

e) reconstruction of an output image from the calculated output image strips;

wherein during steps a)-c) all processed data (data of the image strips, data of the associated detail images of the multi-resolution of the image strips) is in each case located in the cache memory.

Using such a data processing unit, the above-described method can be carried out very efficiently and quickly, since all the necessary data can be accommodated in the cache memory and thus can be accessed rapidly. By contrast, in conventional multi-resolution, in each case the full image is analyzed, as a result of which use must be made of the system memory (working memory, hard disk, etc.) for the storage of the intermediate results. A large part of the calculation time is thus taken up with the reading and writing of the data to and from the system memory. Because these time-consuming operations are omitted, it is possible using the above data processing unit to carry out the image processing even in real time.

Preferably, the data processing unit is equipped with parallel processors and/or vector processors. In this case, the necessary operations can be speeded up even further by means of parallelization.

Furthermore, the data processing unit is preferably designed such that it can also carry out the variants of the method explained above.

The invention further relates to an X-ray system comprising:

an X-ray source;

an X-ray detector;

a data processing unit, coupled to the X-ray detector, for processing the X-ray input images generated by the X-ray detector, where the data processing unit is designed in the above-described manner.

The advantage of such an X-ray system is that effective image processing can be carried out in real time, i.e. during a medical intervention, said image processing suppressing noise without impairing structures of interest. In particular, an MRGAF method can be carried out in real time. On account of the suppression of noise, which allows information to be obtained, it is possible to take X-ray photographs with a correspondingly low dose of radiation, and thus to minimize the amount of radiation to which the patient and the staff are subjected.

The invention will be further described with reference to examples of embodiments shown in the drawings to which, however, the invention is not restricted.

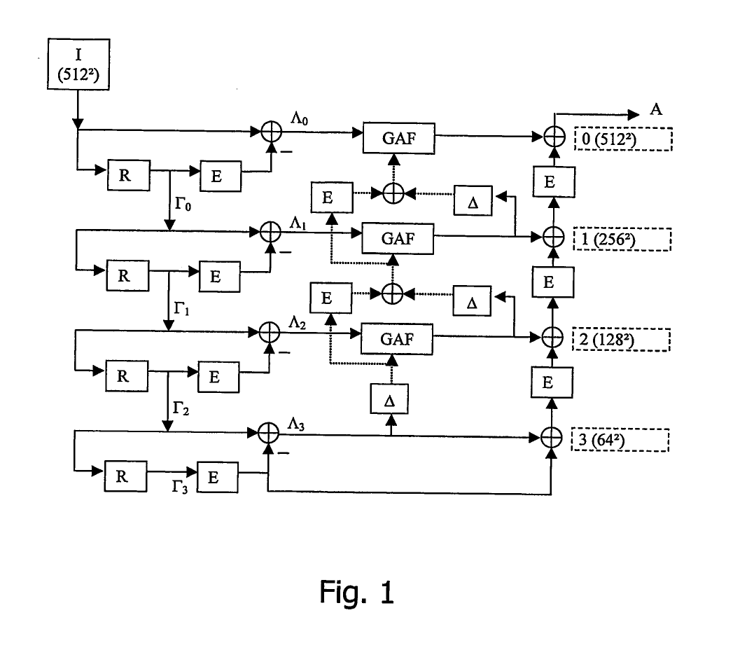

FIG. 1 shows the sequence of an MRGAF algorithm according to the prior art;

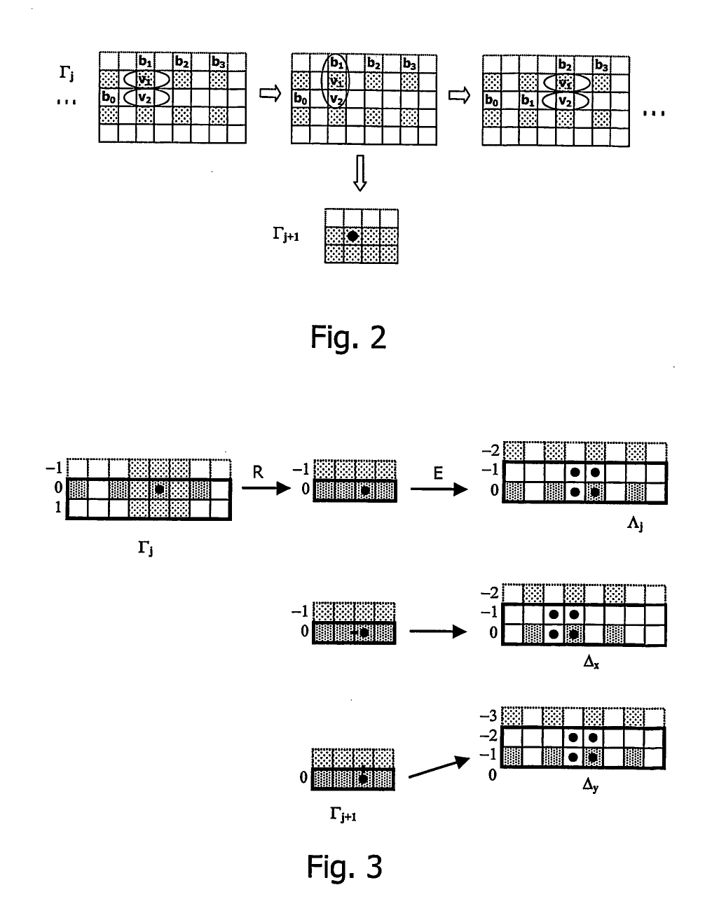

FIG. 2 shows the use of variables in the low-pass filtering and resolution reduction during the generation of a Gaussian pyramid representation of the next-higher resolution stage;

FIG. 3 shows the calculation of the Laplacian pyramid representation and of the gradient fields in the x- and y-direction from two successive Gaussian pyramid representations;

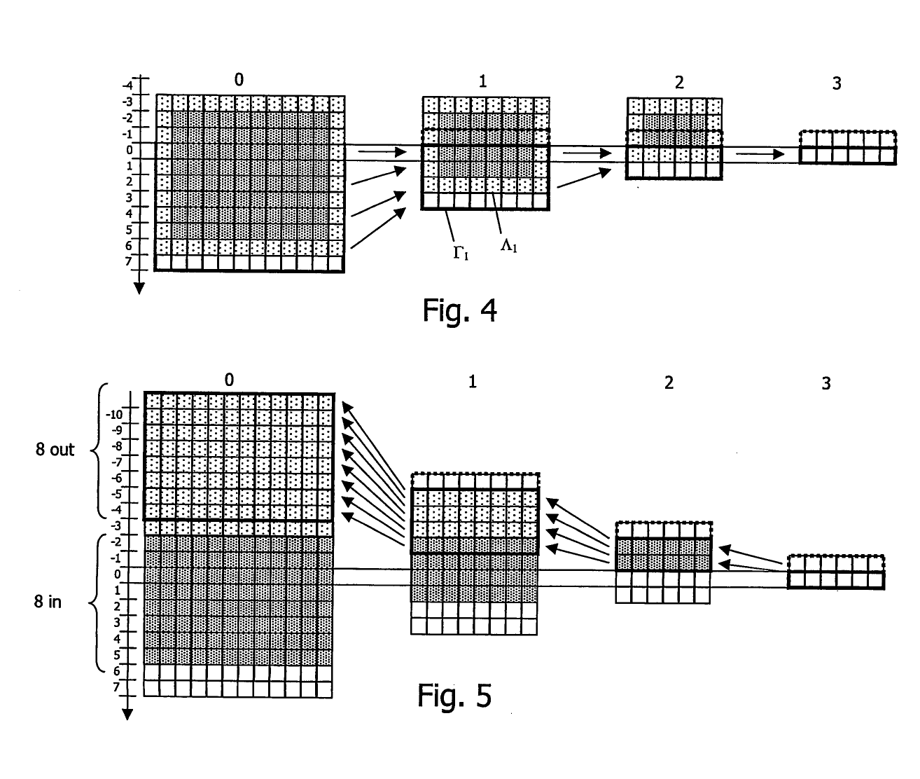

FIG. 4 shows the position of the image points in various resolution stages;

FIG. 5 shows the position of the image points in various composition stages;

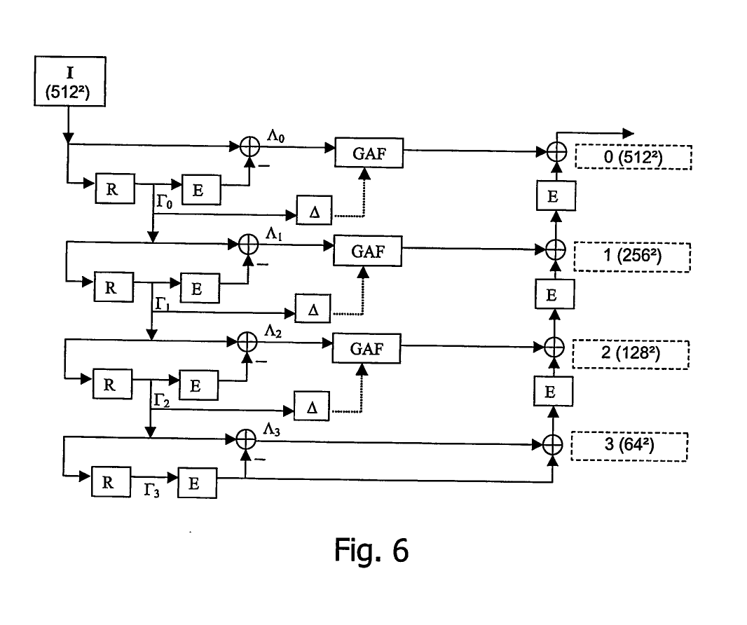

FIG. 6 shows the sequence of an MRGAF algorithm according to the invention.

The MRGAF algorithm shown schematically in FIG. 1 is described in detail in EP 996 090 A2 and WO 98/55916 A1 and shall therefore only be described by way of an overview below. The aim of the MRGAF algorithm is to significantly reduce the noise in an input image I while at the same time maintaining the image details and the image sharpness. The basic idea of the algorithm consists in a multi-resolution and an anisotropic low-pass filtering of the resulting detail images as a function of the local image gradient.

In the example shown in FIG. 1, resolution of the input image I, which comprises 512×512 image points (pixels), takes place in K=4 resolution stages. At each resolution stage j=0, 1, 2, 3, what is known as a Laplacian pyramid representation Λⱼ and a Gaussian pyramid representation Γⱼ is generated as detail image. The stage input representation is in each case the Gaussian pyramid representation Γⱼ₋₁ of the preceding stage (j−1) or the original input representation L The Gaussian pyramid representation Γⱼ is generated by using a reduction operation R on the respective stage input representation, where a “reduction” means a low-pass filtering (smoothing) and subsequent resolution reduction (subsampling) by the factor 2, which leads to an image of half the size. The Laplacian pyramid representations Λⱼ are defined as the difference between the stage input representation and the copy thereof after passing through the reduction R and expansion E blocks. The “expansion” E here includes a resolution increase by the factor 2 (by inserting zeros) and a subsequent low-pass filtering (interpolation). In this case, 3×3 binomial filters are used for the low-pass filtering operations in the reduction R and the expansion E. The Laplacian pyramid representations Λⱼ accordingly contain the high-pass fraction and the Gaussian pyramid representations Γⱼ contain the associated low-pass fraction of the resolution stage j (cf. B. Jähne, Digitale Bild-verarbeitung [Digital Image Processing], 5th edition, Springer Verlag Berlin Heidelberg, 2002, Section 11.4, 5.3).

In preparation for the gradient filtering, by means of simple difference formation between adjacent pixels the gradients Δ are furthermore calculated from the Laplacian pyramid representations Λⱼ. The respective difference in this case belongs to a location in the center between the pixels used for difference formation. Furthermore, although the gradient is calculated at the resolution stage j, it is used for filtering at the preceding, finer resolution stage (j−1). For these reasons, the gradients have to be suitably interpolated. Finally, the result is again divided by the factor 2, in order to compensate for the finer sampling. Since the modulus of the band-pass image does not only assume maximum values in the event of discontinuities in the original image but also in the vicinity thereof, the gradients of the coarser resolution stages j′>j are expanded in the block E and added to the gradient of the resolution stage j.

With the exception of the coarsest resolution stage, all Laplacian pyramid representations Λ₀ to Λ₂ are filtered using a filter GAF, which reacts adaptively to the gradients calculated as described. The starting point of the filter synthesis is in this case a 3×3 binomial filter, the filter coefficients β(Δ\vec{x}) of which are maintained along the main directions of the representation structures, while the coefficients in the direction of the gradients to these structures are reduced according to the following formula:
α(Δ\vec{x},\vec{x})=β(Δ\vec{x})r(\vec{g}(\vec{x}),Δ\vec{x})r(\vec{g}(\vec{x}+Δ\vec{x}),Δ\vec{x}) (3)
where α(Δ\vec{x},\vec{x}) is the new coefficient of the filter, \vec{x} is the image position to be filtered, Δ\vec{x} is the vector pointing from the center of the filter core to the coefficient in question, β(Δ\vec{x}) is the original filter coefficient, r is a weighting function and \vec{g}(\vec{x}) is the gradient at the image point \vec{x}. The weighting function r drops exponentially with the scalar product of the gradient and of the coefficient direction Δ\vec{x} as shown in

$$r ( {g}^{->} , Δ {x}^{->} ) = exp ( - \frac{{( {g}^{->} \cdot Δ {x}^{->} )}^{2}}{c + t \cdot Var ( {g}^{->} ) + L {‖ {g}^{->} ‖}^{2}} ) \qquad ( 4 )$$
where c, t and L are parameters that can be defined by the user and Var(\vec{g}(\vec{x})) is the estimated variance of the noise of the gradient field.

As can be seen in FIG. 1, the calculation of the gradient-adaptive filter GAF presupposes the already processed and reconstructed Gaussian pyramid with the representations Γⱼ.

The right-hand part of the diagram in FIG. 1 reflects the synthesis of an output image A from the detail images Λⱼ (which are unmodified or have been modified by a filtering GAF) by means of successive addition and expansion E. If no filtering of the detail images were to have taken place, the output image A would be identical to the input image I.

A disadvantage of the described MRGAF algorithm is that to date it can only be carried out offline on stored images or image sequences on account of the high calculation effort. Because of the significant image improvement that can be achieved with this algorithm, however, it would be desirable to be able to carry it out also in real time, for example during an ongoing medical intervention. This aim is achieved in the manner described below using various optimizations, but particularly by an approach for processing what are known as “super-rows”. This processing principle cannot only be used in the case of the MRGAF algorithm considered here by way of example; rather it can be used in principle in all types of multi-resolution and also with other comparable algorithms, such as for example a “sub-band coding”.

The above-described original MRGAF algorithm processes the data in a level by level manner. First, the input image I is low-pass-filtered. Since the images are typically too large to pass into a (buffer) memory with rapid access by the processor (cache), some of the input data and some of the processed data must be read from or written to the main or system memory (working memory RAM and/or bulk memory, such as e.g. hard disk). However, this is disadvantageous for two reasons: firstly, the accesses to the system memory are relatively slow and, secondly, memory hardware does not progress as rapidly in technological terms as data processing hardware with regard to the increase in speed. Therefore, it has been sought to change the MRGAF algorithm in such a way that the number of memory accesses is reduced.

In order to reduce the number of read/write operations on the system memory, the calculations of the Gaussian pyramid representations and of the Laplacian pyramid representations and also of the gradient fields at each resolution stage j are combined with one another, so that these values are calculated locally in a single pass over the stage input image. For this purpose, the low-pass-filtered and resolution-reduced value of the next-coarser Gaussian pyramid representation Γⱼ₊₁ must first be calculated. The fastest way to do this is shown schematically in FIG. 2. Instead of using a 3×3 binomial low-pass filter (1,2,1; 2,4,2; 1,2,1)· 1/16, multiplication and addition operations can be saved by using the one-dimensional low-pass filter (1,2,1)·¼ successively in the x- and y-direction (that is to say in the row and column direction) and by buffering the intermediate values bᵢ. Specifically, the algorithm shown in FIG. 2 for calculating a value from Γⱼ₊₁ (point in FIG. 2) proceeds as follows:

| Let | | |
|---|---|---|
| x_{0,0} | x_{0,1} | x_{0,2} |
| x_{1,0} | x_{1,1} | x_{1,2} |
| x_{2,0} | x_{2,1} | x_{2,2} |

be a 3 × 3 proximity around the current position x_{1,1} and
b₁ = x_{0,0} + x_{0,1} + x_{0,1} + x_{0,2}
be a value buffer-stored from the preceding row.

The following steps are then carried out, where v₁, v₂ are temporary variables and b₀, b₁, b₂, . . . are buffer variables:
1. vᵢ=x_{1,0}+x_{1,1}+x_{1,1}+x_{1,2}
2. v₂=x_{2,0}+x_{2,1}+x_{2,1}+x_{2,2}
3. result= 1/16*(b₁+v₁+v₁+v₂)→enter in Γⱼ₊₁
4. b₁=v₂
(etc.)

Furthermore, as shown in FIG. 3, the resulting value of the Gaussian pyramid representation Γⱼ₊₁ is used directly to calculate in each case four values in the Laplacian pyramid representation Λⱼ and in the gradient fields Δₓ in the x-direction and Δ_{y} in the y-direction (cf. marked points in FIG. 3). The Laplacian values are obtained here from the subtraction

of the current value of the Gaussian pyramid representation Γⱼ₊₁ and of the values interpolated herewith in relation to the already calculated neighbors in Γⱼ₊₁ to the left of and above the current position

of the corresponding values of the Gaussian pyramid representation Γⱼ.

The gradient values are the difference from the already calculated values of the Gaussian pyramid representation Γⱼ₊₁ to the left of and above the current position (short dash in FIG. 3) and the interpolated values using the already calculated values in the gradient fields. By virtue of the resolution increase that is carried out at the same time, it is possible to set the calculated differences at the correct “intermediate positions”.

Using the described memory-optimized calculation of the data required for the GAF routine, the MRGAF algorithm can already be carried out around 15% quicker. A further significant increase in efficiency is achieved by the innovation that the overall resolution is carried out with the smallest possible amount of data, so that the data required in this case can be buffered in a memory with rapid access (cache). In this case, the read/write operations for the input image and the output image are the only accesses to the slower system memory that are still required.

Since a read/write command at a memory address always leads to the reading/writing of the entire subsequent data block from or to the cache, the processing of complete rows is retained. However, it is not the entire input image I which is processed in one go, but rather only as few rows as possible. This means that, as shown in FIG. 4, the Gaussian pyramid representation Γ₃ of the coarsest resolution stage only comprises a single row together with the preceding row, which is required for interpolation and difference calculation. Therefore, on account of the pyramid structure, a “super-row” of 2^{K} rows must be processed at the same time, where K is the maximum resolution stage (e.g. K=3 in FIGS. 4, 5).

FIG. 3 can be seen as a representation of the calculation of the Laplacian pyramid block and of the gradient blocks at the coarsest resolution stage. The blocks comprise two rows plus an additional preceding row for the interpolation. As can be seen in FIG. 3, a displacement takes place on account of the reduction, the re-expansion and the interpolation. If the relative rows 0 and 1 are given as input, the gradient-adaptive filtering GAF can be carried out only on the rows −1 and −2 of the Laplacian pyramid block. The reason for this is the position of the resulting data of the y-gradient and the fact that the filtering with a 3×3 GAF filter core requires a pixel of additional data at each side of the filter position. This additional data is the rows 0 and −3 (not shown in FIG. 3) and the first and last columns of the Laplacian pyramid block.

FIG. 4 shows how the displacement effect responds at the other resolution stages. It can be seen that the filtered area (dark gray) always lies two rows above the current position and the Laplacian pyramid block Λⱼ (light gray) lies one row above the current position, where the latter is expanded at the top by two preceding rows in order to permit a 3×3 filtering operation.

In the last step of the method, the image block is reconstructed from the filtered Laplacian pyramid representations. As shown in FIG. 5, the displacement of the filtered data by two rows is summed during the synthesis step, and this results in a relatively large displacement of the reconstructed image block. However, this does not mean that the data have been rewritten at the wrong points; all values pass back to where they came from. In reality, it is not a displacement in terms of location, but rather in terms of time on account of the causality condition that means interpolation can only take place with already calculated values. The light gray areas in FIG. 5 therefore distinguish previously filtered data that has to last until synthesis. In this respect, however, a considerable amount of buffer data can be saved by simply swapping the steps of filtering and synthesis: firstly, the only three rows that are still required for synthesis are filtered (two rows from resolution stage 2 and one row from stage 1—dark gray in FIG. 5). Then the synthesis is carried out, so that the data in the reconstruction buffers can be overwritten with the remaining filter values (dark gray). As a result of this swapping, the reconstruction buffer of stage 0 for example does not need to keep nine additional preceding rows ready, but rather just one. This number would be 3, 5, 7, . . . if more resolution stages were used.

The following calculation estimates the overall memory requirement for buffering data in the above method. It is assumed here that the image width is 512 pixels, a three-stage pyramid is used, and 4 byte floating decimal values are used for all calculations.

$$\begin{matrix}Gaussian pyramid : & 4 * [ 512 * 8 + 256 * ( 4 + 1 ) + 128 * ( 2 + 1 ) + 64 * ( 1 + 1 ) ] & = 23 \; 552 bytes \\ Laplacian pyramid : & 4 * [ 512 * ( 8 + 2 ) + 256 * ( 4 + 2 ) + 128 * ( 2 + 2 ) ] & = 28 \; 672 bytes \\ Gradient fields : & 2 * 4 * [ 512 * ( 8 + 1 ) + 256 * ( 4 + 1 ) + 128 * ( 2 + 1 ) ] & = 50 \; 176 bytes \\ Synthesis buffer : & 4 * [ 512 * ( 8 + 1 + 1 ) + 256 * ( 4 + 1 ) + 128 * ( 2 + 1 ) ] & = 27 \; 136 bytes \\ & & Σ129 \; 536 bytes\end{matrix}$$

The calculation shows that all calculations can be carried out using data in the second-level cache if the latter has a typical size of 256 kB=262 144 bytes. There is even still space for a further 19 rows of the original image if the result is to be rewritten hereto:
4*19*512=38912 bytes

For a comparison of the above methods, the original version of the MRGAF algorithm can be sketched as follows:

For all levels of the pyramid:
1. Reduction of the stage input image in the x-direction→buffer
2. Reduction of the buffer in the y-direction→Gaussian pyramid representation
3. Expansion of the Gaussian pyramid representation in the y-direction→buffer
4. Expansion of the buffer in the x-direction→second buffer
5. Subtraction of the second buffer from the stage input image→Laplacian pyramid representation

By contrast hereto, in the case of the new algorithm, everything takes place using data from the second-level cache during just a single pass of the image. The pyramid resolution, the gradient calculation, the adaptive filtering and the image synthesis are carried out on image strips that are as narrow as possible.

The size of the temporary buffer memory is derived from the requirement that the coarsest stage of the Gaussian pyramid comprises only one row together with the preceding row for the interpolation. The situation is complicated by the fact that, on account of all re-expansions with interpolations, which are only possible using already processed rows, the filtering can be carried out no further than up to two rows above the lower limit of the read image block (cf. FIG. 4: the y-gradients cannot be calculated for the last two rows). For the coarsest stage of the Laplacian pyramid with a height of two pixels, this means that it is only possible to filter the preceding block. During the reconstruction, this displacement grows from stage to stage. This means that a large amount of data (at least the size of one block) needs to be kept ready and displaced in the buffers in each step. However, by swapping the “filtering” and the “reconstruction”, the number of copying operations can fortunately be reduced. The algorithm is shown schematically in FIG. 6, said algorithm comprising the following steps:

For all image strips of the
size 2ˆ(number of resolution stages)×(image width):
1. For all resolution stages:

Passes of the stage image strips in the x- and y-direction in the 2nd steps, where the following is carried out at each position:

low-pass filtering in the x- and y-direction→one pixel of the Gaussian pyramid representation

expansion of the written pixel back to four pixels (using its neighbor for the interpolation) and direct subtraction thereof from the pixels of the stage input representation→4 pixels of the Laplacian pyramid representation

calculation of the difference between the calculated pixel of the Gaussian pyramid representation and its neighbor, interpolation of the results with previously calculated gradients→4 pixels in the x- and y-gradient fields

2. Filtering of the last two rows of the coarsest stage of the Laplacian pyramid and of the first row from the second-coarsest stage (these rows are still required for the reconstruction, the others are already available)→reconstruction buffer

3. Reconstruction of an image strip from the reconstruction pyramid buffer

4. For all stages other than the coarsest:

copying of the data required in the next step from bottom to top in the reconstruction buffer

filtering of the current Laplacian pyramid strip→reconstruction buffer.

In the text which follows, a series of refinements of the algorithm are described, which contribute to further acceleration.

From a comparison of FIG. 1 with FIG. 6, which shows the MRGAF algorithm according to the invention, an important difference can be seen in the fact that in the new algorithm the gradient fields are calculated at each stage directly from the low-pass-filtered stage input representations. Since the algorithm no longer needs to wait until the next-coarser pyramid stage is filtered, the filtering is now carried out in parallel at all resolution levels.

As shown in equation (4), in the original MRGAF algorithm an exponential function is calculated for each filter coefficient at each filter position and at each resolution stage. In this respect, it is proposed to replace the function exp(−x) with the approximation 1/(1+x), which provides a similar profile for a considerably lower calculation effort. In this way, one arrives at equation (2) for the new filter coefficients.

In the original MRGAF algorithm, as shown in equation (3) each filter coefficient is weighted with two factors r, of which one is calculated with the gradients at the current image position \vec{x} and the other is calculated with the gradients at the coefficient position \vec{x}+Δ\vec{x}. In the case of a 3×3 filter core, therefore, nine different gradient factors have to be calculated for each filtered pixel. By virtue of the gradient calculation at all filter positions, the treatment of curved lines ought to be improved. However, when using 3×3 filters, this procedure proves to be unnecessary, since adjacent gradients interpolated from the coarser pyramid stage are very similar to one another. Instead of equation (3), therefore, the simplified formula as shown in equation (1) is proposed. The calculation of the filter routine is considerably simplified on account of this, since opposite filter coefficients now have the same value and equation (2) needs to be calculated only once, instead of nine times.

The variance of the noise of the gradient field in the denominator of equation (2), Var(\vec{g}(\vec{x})), is approximately replaced by the variance of the noise of the corresponding pixel of the coarser pyramid stage. The quality of the filter result is not impaired by this.

From FIG. 6 it can be seen that, when using the Gaussian pyramid representations for gradient calculation, the coarsest pyramid stage (with Γ₃, Λ₃) is superfluous. The calculation of this stage can therefore be dispensed with. A three-stage filtering operation thus leads to the same result as was previously achieved with a four-stage filtering operation.

On a dual Xeon Pentium 4 with 1.7 GHz and with compilation using an Intel C++ compiler, in the most favorable case the implementation of a program taking account of the simplifications discussed above led to a run time of 0.0229 sec for one image, corresponding to 43.6 images (512×512) per second (i.e. more than thirty (768×564) images/s). The method has thus reached a point such that it is suitable for real-time applications.

1. A method of processing an input image (I) comprising N rows of image points, wherein
a) an image strip comprising n<N adjacent rows of the input image is resolved into a sequence of K detail images (Λ₀, . . . Λ₃; Γ₀, . . . Γ₃), which in each case contain just some of the spatial frequencies of the input image;
b) at least one of the detail images (Λ₀, . . . Λ₂) is modified;
c) an output image strip is reconstructed from the—possibly modified—detail images;
d) steps a), b) and c) are repeated for other image strips of the input image;
e) an output image (A) is reconstructed from the calculated output image strips.

2. A method as claimed in claim 1, characterized in that each image strip is resolved into a Laplacian pyramid and a Gaussian pyramid with K stages.

3. A method as claimed in claim 1, characterized in that the image strips each have a width of 2^{K} rows.

4. A method as claimed in claim 1, characterized in that the modification of a detail image (Λⱼ) of the resolution stage j<K is effected using a filter (GAF), the coefficients of which depend on at least one gradient calculated from the image strip.

5. A method as claimed in claims 2 and 4, characterized in that the gradient is calculated from the Gaussian pyramid representation (Γⱼ) of the j-th resolution stage.

6. A method as claimed in claim 4, characterized in that the filter coefficients α(Δ\vec{x},\vec{x}) are calculated from the coefficients β(Δ\vec{x}) of a predefined filter, according to the formula
α(Δ\vec{x},\vec{x})=β(Δ\vec{x})[r(\vec{g}(\vec{x}),Δ\vec{x})]²
where \vec{x} is the image point processed by the filter operation, Δ\vec{x} is the position of the coefficient relative to the center of the filter, \vec{g}(\vec{x}) is the gradient at the image position \vec{x} and 0≦r≦1.

7. A method as claimed in claim 6, characterized in that
$$r ( {g}^{->} , Δ {x}^{->} ) = ( \frac{1}{1 + c [ {g}^{->} ] {( {g}^{->} \cdot Δ {x}^{->} )}^{2}} ) ,$$
where c[\vec{g}] is a positive factor that is preferably dependent on the gradient field and its variance.

8. A data processing unit for processing a digital input image (I) comprising N rows of image points, which data processing unit contains a system memory and a cache memory and is intended to carry out the following processing steps:
a) resolution of an image strip comprising n<N adjacent rows of the input image into a sequence of K detail images (Λ₀, . . . Λ₃; Γ₀, . . . Γ₃), which in each case contain just some of the spatial frequencies of the input image;
b) modification of at least one of the detail images (Λ₀, . . . Λ₂);
c) reconstruction of an output image strip from the—possibly modified—detail images;
d) repetition of steps a), b) and c) for other image strips of the input image;
e) reconstruction of an output image (A) from the calculated output image strips;
wherein during steps a)-c) all processed data is in each case located in the cache memory.

9. A data processing unit as claimed in claim 8, characterized in that it contains parallel processors and/or vector processors.

10. An X-ray system comprising
an X-ray source;
an X-ray detector;
a data processing unit as claimed in claim 8, coupled to the X-ray detector, for processing the X-ray input images transmitted by the X-ray detector.
